(19) United States
(12) Patent Application Publication
(10) Pub. No.: US 2023/0383113 A1
(43) Pub. Date: Nov. 30, 2023

(54) POLYPROPYLENE FILM USED IN A COOKING BAG

(71) Applicant: NAN YA PLASTICS CORPORATION, TAIPEI (TW)

(72) Inventors: TE-CHAO LIAO, TAIPEI (TW); CHING-YAO YUAN, TAIPEI (TW); Chih-Feng Wang, TAIPEI (TW)

(21) Appl. No.: 17/978,183

(22) Filed: Oct. 31, 2022

(30) Foreign Application Priority Data
May 30, 2022 (TW) 111119961

(51) Int. Cl. C08L 53/00; C08F 210/06; B32B 27/08; B32B 27/32

(52) U.S. Cl. CPC C08L 53/00; C08F 210/06; B32B 27/08; B32B 27/32; B32B 2250/242; B32B 2270/00; B32B 2307/31; B32B 2307/412; B32B 2307/414; B32B 2307/732; B32B 2439/06; B32B 2439/70

(57) ABSTRACT

A polypropylene film used in a cooking bag is provided. The polypropylene film used in the cooking bag is co-extruded to form a three-layered structure, and includes two outer layers and a middle layer arranged therebetween. Each of the outer layers includes a propylene random copolymer, and the propylene random copolymer is formed by aggregation of a propylene monomer and an ethylene monomer. The middle layer includes a propylene block polymer and an ethylene elastomer. The propylene block polymer includes a propylene monomer and an ethylene-propylene polymer, and the ethylene-propylene polymer is dispersed in the propylene monomer to form a sea-island structure. After the polypropylene film used in the cooking bag is placed in an environment having a temperature of 135° C. for 30 minutes, a haze of the polypropylene film used in the cooking bag is less than or equal to 10%.

### CROSS-REFERENCE TO RELATED PATENT APPLICATION

This application claims the benefit of priority to Taiwan Patent Application No. 111119961, filed on May 30, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polypropylene film, and more particularly to a polypropylene film used in a cooking bag.

### BACKGROUND OF THE DISCLOSURE

A conventional cooking bag is applicable for food packaging and has a high heat resistance. However, as a usage frequency of the conventional cooking bag gradually increases, the conventional cooking bag can no longer satisfy user requirements.

Specifically, the conventional cooking bag usually includes an opaque aluminum foil layer and a film attached to the aluminum foil layer. In other words, the conventional cooking bag is designed to be opaque, and a haze of the film attached to the aluminum foil layer is not particularly designed to be within a low value range.

After the conventional cooking bag is used for packaging food and is heated, users may wish to clearly see the packaged food through the conventional cooking bag. However, the conventional cooking bag cannot satisfy such a demand Therefore, how to provide a polypropylene film that is used in the cooking bag and can overcome the above-mentioned problem has become an important issue in the industry.

### SUMMARY OF THE DISCLOSURE

In response to the above-referenced technical inadequacy, the present disclosure provides a polypropylene film used in a cooking bag, and the polypropylene film has a haze less than or equal to 10% after being placed in an environment having a temperature of 135° C. for 30 minutes.

In one aspect, the present disclosure provides a polypropylene film used in a cooking bag. The polypropylene film is co-extruded to form a three-layered structure, and includes two outer layers and a middle layer. Each of the two outer layers includes a propylene random copolymer. The propylene random copolymer is formed by aggregation of a propylene monomer and an ethylene monomer. Based on 100 parts by weight of the propylene random copolymer, a content of the ethylene monomer is 0.01 to 2 parts by weight, and a content of the propylene monomer is 98 to 99.99 parts by weight. A melt index (MI) of the propylene random copolymer is within a range from 1 to 10, and a melting point of the propylene random copolymer is within a range from 147° C. to 155° C. The middle layer is arranged between the two outer layers, and includes a propylene block polymer and an ethylene elastomer. The propylene block polymer includes a propylene monomer and an ethylene-propylene polymer, and the ethylene-propylene polymer is dispersed in the propylene monomer to form a sea-island structure. The sea-island structure includes a sea phase and an island phase, the propylene monomer is defined as the sea phase, and the ethylene-propylene polymer is defined as the island phase. A heat seal strength of the polypropylene film is within a range from 40 N/15 mm to 80 N/15 mm, and after the polypropylene film is placed in an environment having a temperature of 135° C. for 30 minutes, a haze of the polypropylene film is less than or equal to 10%.

In certain embodiments, after the middle layer is placed in the environment having a temperature of 135° C. for 30 minutes, a haze of the middle layer is within a range from 40% to 70%.

In certain embodiments, based on 100 parts by weight of the middle layer, a content of the propylene block polymer is 50 to 95 parts by weight, and a content of the ethylene elastomer is 5 to 50 parts by weight.

In certain embodiments, the ethylene elastomer is at least one selected from the group consisting of an ethylene propylene elastomer, an ethylene butene elastomer, and an ethylene octene elastomer.

In certain embodiments, the middle layer further includes propylene random copolymer. Based on 100 parts by weight of the middle layer, a content of the propylene random copolymer is 5 to 20 parts by weight.

In certain embodiments, based on 100 parts by weight of the propylene block polymer in the middle layer, a content of the propylene monomer is 80 to 90 parts by weight, and a content of the ethylene-propylene polymer is 10 to 20 parts by weight.

In certain embodiments, one of the outer layers includes the propylene random copolymer and a propylene homopolymer that are mixed with each other. Based on 100 parts by weight of the one of the outer layers, a content of the propylene random copolymer is 30 to 95 parts by weight, and a content of the propylene homopolymer is 5 to 70 parts by weight.

In certain embodiments, a melt index (MI) of the propylene homopolymer is within a range from 1 to 10, and a melting point of the propylene homopolymer is within a range from 160° C. to 168° C. A melting point of the one of the outer layers is within a range from 147° C. to 168° C.

In certain embodiments, a thickness of each of the outer layers is 5% to 20% of a thickness of the polypropylene film, and a thickness of the middle layer is 60% to 90% of the thickness of the polypropylene film.

In certain embodiments, a thickness of the polypropylene film is within a range from 50 micrometers to 100 micrometers.

Therefore, in the polypropylene film used in the cooking bag provided by the present disclosure, by virtue of “each of the two outer layers including a propylene random copolymer, and the propylene random copolymer being formed by aggregation of a propylene monomer and an ethylene monomer” and “the middle layer including a propylene block polymer and an ethylene elastomer, the propylene block polymer including a propylene monomer and an ethylene-propylene polymer, and the ethylene-propylene polymer being dispersed in the propylene monomer to form a sea-island structure,” the heat seal strength of the polypropylene film is within a range from 40 N/15 mm to 80 N/15 mm. Further, after the polypropylene film is placed in the environment having the temperature of 135° C. for 30 minutes, the haze of the polypropylene film is less than or equal to 10%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawing, in which:

FIG. 1 is a schematic view of a polypropylene film used in a cooking bag according to a first embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

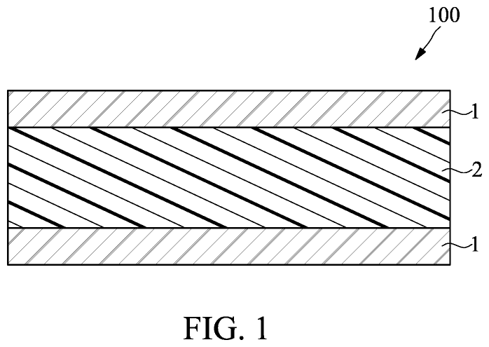

Referring to FIG. 1, FIG. 1 is a schematic view of a polypropylene film used in a cooking bag according to a first embodiment of the present disclosure. A first embodiment of the present disclosure provides a polypropylene film 100 used in a cooking bag, and the polypropylene film 100 used in the cooking bag is co-extruded to form a three-layered structure. The polypropylene film 100 used in the cooking bag includes two outer layers 1 and a middle layer 2, and the middle layer 2 is arranged between the two outer layers 1.

Specifically, since the polypropylene film 100 used in the cooking bag is formed by extrusion after being heated, the outer layers 1 and the middle layer 2 can display their respective properties. In addition, the polypropylene film 100 used in the cooking bag can be integrally formed, and there can be no solvent or adhesive between the middle layer 2 and any one of the outer layers 1. It is worth mentioning that, since the polypropylene film 100 used in the cooking bag of the present disclosure is formed by co-extrusion, the polypropylene film 100 used in the cooking bag is clearly different from a film that is formed by coating. Therefore, the film that is formed by coating is not suitable to be compared to the polypropylene film 100 used in the cooking bag of the present disclosure that is formed by co-extrusion.

The polypropylene film 100 used in the cooking bag is applicable for food packaging. In particular, after the polypropylene film 100 used in the cooking bag is used for packaging food and is heated, a user can clearly see the packaged food through the polypropylene film 100 used in the cooking bag. A heat seal strength of the polypropylene film 100 used in the cooking bag is within a range from 40 N/15 mm to 80 N/15 mm, and the polypropylene film 100 used in the cooking bag has a haze less than or equal to 10% after being placed in an environment having a temperature of 135° C. for 30 minutes.

In other words, after the polypropylene film 100 used in the cooking bag is heated for a certain time interval, the polypropylene film 100 used in the cooking bag can still maintain a low haze. In addition, in the polypropylene film 100 used in the cooking bag, the two outer layers 1 are mainly used to maintain the low haze of the polypropylene film 100 used in the cooking bag, and the middle layer 2 is mainly provided for the overall polypropylene film 100 used in the cooking bag to be impact resistant.

In the present embodiment, a thickness of the polypropylene film 100 used in the cooking bag is within a range from 50 micrometers to 100 micrometers, a thickness of each of the outer layers 1 is 5% to 20% of the thickness of the polypropylene film 100 used in the cooking bag, and a thickness of the middle layer 2 is 60% to 90% of the thickness of the polypropylene film 100 used in the cooking bag. However, the present disclosure is not limited thereto. In other words, the thickness of each of the outer layers 1 can be within a range from 2.5 micrometers to 20 micrometers, and the thickness of the middle layer 2 can be within a range from 30 micrometers to 90 micrometers. Preferably, the thickness of the polypropylene film 100 used in the cooking bag is within a range from 60 micrometers to 90 micrometers.

Each of the outer layers 1 includes propylene random copolymer. The propylene random copolymer is formed by aggregating propylene monomer and ethylene monomer. Based on 100 parts by weight of the propylene random copolymer, a content of the ethylene monomer is 0.01 to 2 parts by weight, and a content of the propylene monomer is 98 to 99.99 parts by weight. In other words, in the propylene random copolymer of the present embodiment, the content of the ethylene monomer is far less than the content of the propylene monomer.

It should be noted that, in the propylene random copolymer, if the content of the ethylene monomer is too high (e.g., higher than 2 parts by weight), the polypropylene film 100 used in the cooking bag may not have a sufficient heat resistance. Conversely, in the propylene random copolymer, if the content of the ethylene monomer is too low (e.g., lower than 0.01 parts by weight), the polypropylene film 100 used in the cooking bag may be too hard and too brittle, such that the polypropylene film 100 used in the cooking bag may be broken.

Therefore, the content of the ethylene monomer should be within a range between 0.01 to 2 parts by weight. A melt index (MI) of the propylene random copolymer is within a range from 1 to 10, and a melting point of the propylene random copolymer is within a range from 147° C. to 155° C. In addition, in the present embodiment, a melting point of each of the outer layers 1 is within a range from 147° C. to 155° C.

In other embodiments, one of the outer layers 1 includes the propylene random copolymer and propylene homopolymer mixed with each other, so as to further increase a heat resistance of the one of the outer layers 1. Based on 100 parts by weight of the one of the outer layers 1, a content of the propylene random copolymer is 30 to 95 parts by weight, and a content of the propylene homopolymer is 5 to 70 parts by weight. A melt index (MI) of the propylene homopolymer is within a range from 1 to 10, and a melting point of the propylene homopolymer is within a range from 160° C. to 168° C. In addition, due to containing the propylene random copolymer and the propylene homopolymer, a melting point of the one of the outer layers 1 is within a range from 147° C. to 168° C.

It is worth mentioning that, each of the outer layers 1 must include the propylene random copolymer. If one of the outer layers 1 only includes the propylene homopolymer and does not include the propylene random copolymer, the polypropylene film 100 used in the cooking bag would be too hard and too brittle, such that the polypropylene film 100 used in the cooking bag may be broken.

The middle layer 2 includes propylene block polymer and ethylene elastomer. The propylene block polymer includes propylene monomer and ethylene-propylene polymer, and the ethylene-propylene polymer is dispersed in the propylene monomer to form a sea-island structure. Specifically, the sea-island structure includes a sea phase and an island phase, the propylene monomer is defined as the sea phase, and the ethylene-propylene polymer is defined as the island phase.

Based on 100 parts by weight of the middle layer 2, a content of the propylene block polymer is 50 to 95 parts by weight, and a content of the ethylene elastomer is 5 to 50 parts by weight.

In the middle layer 2, based on 100 parts by weight of the propylene block polymer, a content of the propylene monomer is 80 to 90 parts by weight, and a content of the ethylene-propylene polymer is 10 to 20 parts by weight.

It should be noted that, the propylene block polymer of the middle layer 2 can provide excellent heat resistance and impact resistance. However, in the propylene block polymer, the content of the propylene monomer and the content of the ethylene-propylene polymer must fall within the above-mentioned range (i.e., the content of the propylene monomer is 80 to 90 parts by weight, and the content of the ethylene-propylene polymer is 10 to 20 parts by weight), or there may be negative effects.

Specifically, in the propylene block polymer, if the content of the ethylene-propylene polymer is too low (e.g., lower than 10 parts by weight), the propylene block polymer may not provide a sufficient impact resistance. Conversely, if the content of the ethylene-propylene polymer is too high (e.g., higher than 20 parts by weight), a production process of the propylene block polymer may be negatively affected. Therefore, the content of the ethylene-propylene polymer should be 10 to 20 parts by weight.

It is worth mentioning that, if the middle layer 2 only includes the propylene block polymer and does not include the ethylene elastomer, the polypropylene film 100 used in the cooking bag may not have a sufficient impact resistance. Accordingly, in addition to the propylene block polymer, the middle layer 2 needs to include the ethylene elastomer to further enhance the impact resistance of the polypropylene film 100 used in the cooking bag. Therefore, if the content of the ethylene elastomer is too low (e.g., lower than 5 parts by weight), the impact resistance of the middle layer 2 or the overall impact resistance of the polypropylene film 100 used in the cooking bag may be too low.

The ethylene elastomer is at least one selected from the group consisting of ethylene propylene elastomer, ethylene butene elastomer, and ethylene octene elastomer. In other words, the ethylene elastomer is selected from a specific material group, so as to ensure that the impact resistance of the middle layer 2 or the polypropylene film 100 used in the cooking bag is not too low.

After the middle layer 2 is placed in the environment having the temperature of 135° C. for 30 minutes, a haze of the middle layer 2 is within a range from 40% to 70%. It should be noted that, if only the middle layer 2 is used as a polypropylene film used in the cooking bag, a haze of the polypropylene film used in the cooking bag is too high. In addition, if the polypropylene film used in the cooking bag is in a two-layered structure and only includes one outer layer 1 and one middle layer 2, after said polypropylene film used in the cooking bag is placed in the environment having the temperature of 135° C. for 30 minutes, the haze thereof is within a range from 40% to 75%. Conversely, the polypropylene film 100 used in the cooking bag of the present disclosure is in the three-layered structure and includes the two outer layers 1 and the middle layer 2. This allows the polypropylene film 100 used in the cooking bag of the present disclosure to have excellent heat seal strength and impact resistance whilst being low in haze.

Furthermore, since the polypropylene film 100 used in the cooking bag of the present disclosure has the low haze, the polypropylene film 100 used in the cooking bag can be used in cooperation with other transparent films. For example, the polypropylene film 100 used in the cooking bag can be used in cooperation with a PET (i.e., polyethylene terephthalate) film or a NY (i.e., nylon) film. Given that each of the above-mentioned films belongs to a polyolefin material, a recycling process of each of the above-mentioned films is relatively easy.

### Second Embodiment

The present embodiment is similar to the first embodiment above, and the similarities therebetween will not be reiterated herein. The difference between these two embodiments is as follows.

In the polypropylene film 100 used in the cooking bag of the present embodiment, the middle layer 2 further includes propylene random copolymer. Based on 100 parts by weight of the middle layer 2, a content of the propylene random copolymer is 5 to 20 parts by weight, the content of the propylene block polymer is 50 to 90 parts by weight, and the content of the ethylene elastomer is 5 to 45 parts by weight, but the present disclosure is not limited thereto.

It is worth mentioning that, in the polypropylene film 100 used in the cooking bag of the present embodiment, the propylene random copolymer in the middle layer 2 can be the same as the propylene random copolymer in the two outer layers 1. In addition, in the present embodiment, since the middle layer 2 includes the propylene random copolymer, the middle layer 2 can be better combined with the two outer layers 1 containing the propylene random copolymer.

### EXPERIMENTAL RESULTS

Hereinafter, a more detailed description will be provided with reference to Exemplary Examples 1 to 5 and Comparative Examples 1 to 3. However, the Exemplary Examples below are only used to aid in understanding of the present disclosure, and are not to be construed as limiting the scope of the present disclosure.

In Exemplary Example 1, the thickness of the polypropylene film 100 used in the cooking bag is 70 micrometers, in which a total thickness of the outer layers 1 is 21 micrometers, and the thickness of the middle layer 2 is 49 micrometers. Each of the outer layers 1 includes 50 parts by weight of the propylene random copolymer and 50 parts by weight of the propylene homopolymer, and the middle layer 2 includes 70 parts by weight of the propylene block polymer and 30 parts by weight of the ethylene elastomer.

In Exemplary Example 2, the thickness of the polypropylene film 100 used in the cooking bag is 50 micrometers, in which a total thickness of the outer layers 1 is 15 micrometers, and the thickness of the middle layer 2 is 35 micrometers. Each of the outer layers 1 includes 50 parts by weight of the propylene random copolymer and 50 parts by weight of the propylene homopolymer, and the middle layer 2 includes 70 parts by weight of the propylene block polymer and 30 parts by weight of the ethylene elastomer.

In Exemplary Example 3, the thickness of the polypropylene film 100 used in the cooking bag is 70 micrometers, in which a total thickness of the outer layers 1 is 21 micrometers, and the thickness of the middle layer 2 is 49 micrometers. Each of the outer layers 1 includes 50 parts by weight of the propylene random copolymer and 50 parts by weight of the propylene homopolymer, and the middle layer 2 includes 85 parts by weight of the propylene block polymer, 10 parts by weight of the ethylene elastomer, and 5 parts by weight of the propylene random copolymer.

In Exemplary Example 4, the thickness of the polypropylene film 100 used in the cooking bag is 70 micrometers, in which a total thickness of the outer layers 1 is 21 micrometers, and the thickness of the middle layer 2 is 49 micrometers. Each of the outer layers 1 includes 30 parts by weight of the propylene random copolymer and 70 parts by weight of the propylene homopolymer, and the middle layer 2 includes 70 parts by weight of the propylene block polymer, 25 parts by weight of the ethylene elastomer, and 5 parts by weight of the propylene random copolymer.

In Exemplary Example 5, the thickness of the polypropylene film 100 used in the cooking bag is 70 micrometers, in which a total thickness of the outer layers 1 is 21 micrometers, and the thickness of the middle layer 2 is 49 micrometers, each of the outer layers 1 includes 100 parts by weight of the propylene random copolymer, and the middle layer 2 includes 80 parts by weight of the propylene block polymer and 20 parts by weight of the ethylene elastomer.

In Comparative Example 1, the thickness of the polypropylene film 100 used in the cooking bag is 70 micrometers, in which a total thickness of the outer layers 1 is 21 micrometers, and the thickness of the middle layer 2 is 49 micrometers. Each of the outer layers 1 includes 100 parts by weight of the propylene homopolymer, and the middle layer 2 includes 70 parts by weight of the propylene block polymer and 30 parts by weight of the ethylene elastomer.

In Comparative Example 2, the thickness of the polypropylene film 100 used in the cooking bag is 70 micrometers. The polypropylene film 100 used in the cooking bag only includes the middle layer 2 having the thickness of 70 micrometers (without the outer layers 1), and the middle layer 2 includes 70 parts by weight of the propylene block polymer and 30 parts by weight of the ethylene elastomer.

In Comparative Example 3, the thickness of the polypropylene film 100 used in the cooking bag is 70 micrometers, in which a total thickness of the outer layers 1 is 21 micrometers, and the thickness of the middle layer 2 is 49 micrometers. Each of the outer layers 1 includes 50 parts by weight of the propylene random copolymer and 50 parts by weight of the propylene homopolymer, and the middle layer 2 includes 100 parts by weight of the propylene block polymer.

For the polypropylene film 100 used in the cooking bag of each of Exemplary Examples 1 to 5 and Comparative Examples 1 to 3, components, a melt index, a heat seal strength, a haze and an impact resistance thereof are listed in Table 1 below, and relevant testing methods are described as follows.

A melt index test is carried out according to ASTM D1238.

A heat seal strength test includes: heat sealing two CPP films at a temperature of 180° C. and a pressure of 0.2 MPa for 1 second, and using a tensile testing machine to test the heat seal strength at a speed of 300 M/min.

A haze test is carried out according to ASTM D1003.

An impact resistance test is carried out according to ASTM D3420.

TABLE 1
[Components of Exemplary Examples and Comparative Examples
and Test Results of Their Physical and Chemical Properties]

| | | Exemplary | Exemplary | Exemplary | Exemplary | Exemplary |
|---|---|---|---|---|---|---|
| Item | | Example 1 | Example 2 | Example 3 | Example 4 | Example 5 |
| Parameter | thickness of the | 70 | 50 | 70 | 70 | 70 |
| of each | polypropylene | | | | | |
| component | film used in the | | | | | |
| | cooking bag | | | | | |
| | (micrometer) | | | | | |
| | thickness of the | 21 | 15 | 21 | 21 | 21 |
| | outer layers | | | | | |
| | (micrometer) | | | | | |
| | thickness of the | 49 | 35 | 49 | 49 | 49 |
| | middle layer | | | | | |
| | (micrometer) | | | | | |
| | content of the | 50 | 50 | 50 | 30 | 100 |
| | propylene random | | | | | |
| | copolymer in each | | | | | |
| | of the outer layers | | | | | |
| | (parts by weight) | | | | | |
| | content of the | 50 | 50 | 50 | 70 | 0 |
| | propylene | | | | | |
| | homopolymer in | | | | | |
| | each of the outer | | | | | |
| | layers (parts by | | | | | |
| | weight) | | | | | |
| | melt index (MI) | 7 | 7 | 7 | 7 | 7 |
| | of the propylene | | | | | |
| | random copolymer | | | | | |
| | in each of the | | | | | |
| | outer layers | | | | | |
| | melt index (MI) | 7 | 3 | 7 | 7 | 7 |
| | of the propylene | | | | | |
| | homopolymer in | | | | | |
| | each of the outer | | | | | |
| | layers | | | | | |
| | content of the | 70 | 70 | 85 | 70 | 80 |
| | propylene block | | | | | |
| | polymer in the | | | | | |
| | middle layer | | | | | |
| | (parts by weight) | | | | | |
| | content of the | 30 | 30 | 10 | 25 | 20 |
| | ethylene elastomer | | | | | |
| | in the middle | | | | | |
| | layer (parts by | | | | | |
| | weight) | | | | | |
| | content of the | 0 | 0 | 5 | 5 | 0 |
| | propylene random | | | | | |
| | copolymer in the | | | | | |
| | middle layer | | | | | |
| | (parts by weight) | | | | | |
| Test | heat seal strength | 58 | 54 | 60 | 63 | 51 |
| results | of the polypropylene | | | | | |
| | film used in the | | | | | |
| | cooking bag | | | | | |
| | (N/15 mm) | | | | | |
| | haze of the | 8.2 | 7.0 | 8.7 | 9.5 | 6.2 |
| | polypropylene | | | | | |
| | film used in the | | | | | |
| | cooking bag (%) | | | | | |
| | after placement in | | | | | |
| | the environment | | | | | |
| | having the | | | | | |
| | temperature of | | | | | |
| | 135° C. for 30 | | | | | |
| | minutes | | | | | |
| | impact resistance | 99 | 87 | 81 | 90 | 97 |
| | of the polypropylene | | | | | |
| | film used in the | | | | | |
| | cooking bag | | | | | |
| | at −5° C. (J/cm) | | | | | |
| | haze of the | 6.0 | 5.4 | 6.5 | 8.1 | 4.8 |
| | polypropylene | | | | | |
| | film used in the | | | | | |
| | cooking bag (%) | | | | | |

| | | Comparative | Comparative | Comparative |
|---|---|---|---|---|
| Item | | Example 1 | Example 2 | Example 3 |
| Parameter | thickness of the | 70 | 70 | 70 |
| of each | polypropylene film used | | | |
| component | in the cooking bag | | | |
| | (micrometer) | | | |
| | thickness of the outer | 21 | 0 | 21 |
| | layers (micrometer) | | | |
| | thickness of the middle | 49 | 70 | 49 |
| | layer (micrometer) | | | |
| | content of the propylene | 0 | 0 | 50 |
| | random copolymer in | | | |
| | each of the outer layers | | | |
| | (parts by weight) | | | |
| | content of the propylene | 100 | 0 | 50 |
| | homopolymer in each of | | | |
| | the outer layers (parts by | | | |
| | weight) | | | |
| | melt index (MI) of the | — | — | 7 |
| | propylene random | | | |
| | copolymer in each of the | | | |
| | outer layers | | | |
| | melt index (MI) of the | 7 | — | 7 |
| | propylene homopolymer | | | |
| | in each of the outer layers | | | |
| | content of the propylene | 70 | 70 | 100 |
| | block polymer in the | | | |
| | middle layer (parts by | | | |
| | weight) | | | |
| | content of the ethylene | 30 | 30 | 0 |
| | elastomer in the middle | | | |
| | layer (parts by weight) | | | |
| | content of the propylene | 0 | 0 | 0 |
| | random copolymer in the | | | |
| | middle layer (parts by | | | |
| | weight) | | | |
| Test | heat seal strength of the | 65 | 55 | 54 |
| results | polypropylene film used | | | |
| | in the cooking bag | | | |
| | (N/15 mm) | | | |
| | haze of the polypropylene | 22. | 68 | 70 |
| | film used in the cooking | | | |
| | bag (%) after placement | | | |
| | in the environment having | | | |
| | the temperature of 135° C. | | | |
| | for 30 minutes | | | |
| | impact resistance of the | 95 | 105 | 60 |
| | polypropylene film used | | | |
| | in the cooking bag | | | |
| | at −5° C. (J/cm) | | | |
| | haze of the polypropylene | 20 | 65 | 68 |
| | film used in the cooking | | | |
| | bag (%) | | | |

### Discussion of Test Results

As shown in Exemplary Example 1 and Comparative Example 1, if each of the outer layers only includes the propylene homopolymer (i.e., no propylene random copolymer is added), an initial haze of the polypropylene film used in the cooking bag already reaches 20%, thereby failing to meet the 10% requirement.

As shown in Exemplary Example 1 and Comparative Example 2, if the polypropylene film used in the cooking bag only includes the middle layer, even though the polypropylene film used in the cooking bag has a relatively high impact resistance, its overall haze reaches 65%. Hence, such a polypropylene film used in the cooking bag cannot be easily seen through.

As shown in Exemplary Example 1 and Comparative Example 3, if the middle layer is not added with the ethylene elastomer, the impact resistance of the polypropylene film is relatively poor, such that the polypropylene film is not suitable to be used in the cooking bag.

As shown in Exemplary Example 1 and Exemplary Example 5, the outer layers of the polypropylene film in Exemplary Example 5 do not include the propylene homopolymer. As a result, the haze of the polypropylene film in Exemplary Example 5 is relatively low (4.8), and the heat seal strength of the polypropylene film in Exemplary Example 5 is slightly lower than that of the polypropylene film in Exemplary Example 1. However, the overall properties of the polypropylene film in Exemplary Example 5 are still applicable to a cooking bag product.

### Beneficial Effects of the Embodiments

In conclusion, in the polypropylene film used in the cooking bag provided by the present disclosure, by virtue of “each of the two outer layers including a propylene random copolymer, and the propylene random copolymer being formed by aggregation of a propylene monomer and an ethylene monomer” and “the middle layer including a propylene block polymer and an ethylene elastomer, the propylene block polymer including a propylene monomer and an ethylene-propylene polymer, and the ethylene-propylene polymer being dispersed in the propylene monomer to form a sea-island structure,” the heat seal strength of the polypropylene film is within a range from 40 N/15 mm to 80 N/15 mm. Further, after the polypropylene film is placed in the environment having the temperature of 135° C. for 30 minutes, the haze of the polypropylene film is less than or equal to 10%.

Further, in the polypropylene film used in the cooking bag, one of the outer layers can include the propylene random copolymer and the propylene homopolymer, so as to further increase the heat resistance of the polypropylene film used in the cooking bag.

In addition, the middle layer can include the propylene block polymer, the ethylene elastomer, and the propylene random copolymer, which allow the polypropylene film used in the cooking bag to be impact resistant and enhance a combination between the middle layer and the two outer layers.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A polypropylene film used in a cooking bag, characterized in that the polypropylene film is co-extruded to form a three-layered structure, the polypropylene film comprising:
two outer layers, wherein each of the two outer layers includes a propylene random copolymer, and the propylene random copolymer is formed by aggregation of a propylene monomer and an ethylene monomer; wherein, based on 100 parts by weight of the propylene random copolymer, a content of the ethylene monomer is 0.01 to 2 parts by weight, and a content of the propylene monomer is 98 to 99.99 parts by weight; wherein a melt index (MI) of the propylene random copolymer is within a range from 1 to 10, and a melting point of the propylene random copolymer is within a range from 147° C. to 155° C.; and
a middle layer arranged between the two outer layers, wherein the middle layer includes a propylene block polymer and an ethylene elastomer; wherein the propylene block polymer includes a propylene monomer and an ethylene-propylene polymer, and the ethylene-propylene polymer is dispersed in the propylene monomer to form a sea-island structure; wherein the sea-island structure includes a sea phase and an island phase, the propylene monomer is defined as the sea phase, and the ethylene-propylene polymer is defined as the island phase;
wherein a heat seal strength of the polypropylene film is within a range from 40 N/15 mm to 80 N/15 mm; wherein, after the polypropylene film is placed in an environment having a temperature of 135° C. for 30 minutes, a haze of the polypropylene film is less than or equal to 10%.

2. The polypropylene film according to claim 1, wherein, after the middle layer is placed in the environment having the temperature of 135° C. for 30 minutes, a haze of the middle layer is within a range from 40% to 70%.

3. The polypropylene film according to claim 1, wherein, based on 100 parts by weight of the middle layer, a content of the propylene block polymer is 50 to 95 parts by weight, and a content of the ethylene elastomer is 5 to 50 parts by weight.

4. The polypropylene film according to claim 1, wherein the ethylene elastomer is at least one selected from the group consisting of an ethylene propylene elastomer, an ethylene butene elastomer, and an ethylene octene elastomer.

5. The polypropylene film according to claim 1, wherein the middle layer further includes a propylene random copolymer; wherein, based on 100 parts by weight of the middle layer, a content of the propylene random copolymer is 5 to 20 parts by weight.

6. The polypropylene film according to claim 1, wherein, based on 100 parts by weight of the propylene block polymer in the middle layer, a content of the propylene monomer is 80 to 90 parts by weight, and a content of the ethylene-propylene polymer is 10 to 20 parts by weight.

7. The polypropylene film according to claim 1, wherein one of the outer layers includes the propylene random copolymer and a propylene homopolymer that are mixed with each other; wherein, based on 100 parts by weight of the one of the outer layers, a content of the propylene random copolymer is 30 to 95 parts by weight, and a content of the propylene homopolymer is 5 to 70 parts by weight.

8. The polypropylene film according to claim 7, wherein a melt index (MI) of the propylene homopolymer is within a range from 1 to 10, and a melting point of the propylene homopolymer is within a range from 160° C. to 168° C.; wherein a melting point of the one of the outer layers is within a range from 147° C. to 168° C.

9. The polypropylene film according to claim 1, wherein a thickness of each of the outer layers is 5% to 20% of a thickness of the polypropylene film, and a thickness of the middle layer is 60% to 90% of the thickness of the polypropylene film.

10. The polypropylene film according to claim 1, wherein a thickness of the polypropylene film is within a range from 50 micrometers to 100 micrometers.
